(19) United States
(12) Patent Application Publication
(10) Pub. No.: US 2013/0043668 A1
(43) Pub. Date: Feb. 21, 2013

(54) MOTORCYCLE FOOTREST PEG REINFORCEMENT

(71) Applicants: Jimmie B. Allred, III, Skaneateles, NY (US); Michael D. Griswold, Syracuse, NY (US)

(72) Inventors: Jimmie B. Allred, III, Skaneateles, NY (US); Michael D. Griswold, Syracuse, NY (US)

(73) Assignee: Allred & Associates Inc., Elbridge, NY (US)

(21) Appl. No.: 13/586,216

(22) Filed: Aug. 15, 2012

Related U.S. Application Data
(60) Provisional application No. 61/523,427, filed on Aug. 15, 2011.

(51) Int. Cl. B62J 25/00

(52) U.S. Cl. 280/291

(57) ABSTRACT

A footrest peg reinforcement is designed for use on motorcycles. The reinforcement includes an expansion plug, a fastener, such as a threaded stud or a bolt, and a support plate added to a standard footrest peg assembly. In a preferred embodiment, the support plate is made from carbon fiber.

### REFERENCE TO RELATED APPLICATIONS

This application claims one or more inventions which were disclosed in Provisional Application Number 61/523,427, filed Aug. 15, 2011, entitled “MOTORCYCLE FOOTREST PEG REINFORCEMENT”. The benefit under 35 USC § 119(e) of the United States provisional application is hereby claimed, and the aforementioned application is hereby incorporated herein by reference.

### BACKGROUND OF THE INVENTION

1. Field of the Invention

The invention pertains to the field of motorcycles. More particularly, the invention pertains to motorcycle footrest pegs.

2. Description of Related Art

Due to the widespread use of footrest pegs in motorcycles, there exists extensive prior art related to the design of footrest pegs. However, very little prior art specifically addresses the strength of the footrest peg attachment to the motorcycle frame. U.S. Pat. No. 7,281,727 (Rogozienski) discloses a motorcycle footrest peg adapted to bear the weight of a rider. Rogozienski uses a cradle bracket to attach the footrest peg assembly to the motorcycle frame.

### SUMMARY OF THE INVENTION

In one preferred embodiment, a motorcycle footrest peg assembly includes a motorcycle footrest peg, a peg support plate connected to the footrest peg, an expansion plug and a fastener, such as a threaded stud or bolt, inserted into an engine mounting hole or recess in a motorcycle frame, and a reinforcement support plate connected to the peg support plate and the threaded stud, where the reinforcement support plate indirectly connects the peg support to the motorcycle frame using the threaded stud.

In one preferred embodiment, a motorcycle footrest peg reinforcement includes a support plate that connects a footrest peg support to another strong frame location, such as an engine mounting hole, thus providing stress relief for the metal tabs and preventing frame damage.

### BRIEF DESCRIPTION OF THE DRAWINGS

FIG. 1A shows a motorcycle.

FIG. 1B shows a close-up of the footrest peg assembly of the motorcycle of FIG. 1A.

FIG. 2 shows a prior art footrest peg assembly.

FIG. 3 shows the motorcycle frame and metal tabs of FIG. 2.

FIG. 4 shows an expansion plug and threaded stud mounted into the motorcycle frame in an embodiment of the present invention.

FIG. 5 shows a support plate mounted to the motorcycle frame in an embodiment of the present invention.

FIG. 6 shows alternate mounting hardware for the support plate to the motorcycle frame.

FIG. 7 shows an expansion plug and bolt mounted into the motorcycle frame within an embodiment of the present invention.

FIG. 8 shows the aluminum peg support being mounted to the support plate in an embodiment of the present invention.

FIG. 9 shows the complete footrest peg assembly mounted to the motorcycle frame in an embodiment of the present invention.

FIG. 10 shows an alternate view of the footrest peg assembly shown in FIG. 9.

### DETAILED DESCRIPTION OF THE INVENTION

The term “motorcycle”, as used herein, includes both two and three wheeled motorcycles and also four wheeled all terrain vehicles.

Footrest pegs have been standard equipment on motorcycles for many years. There exists, however, a clear deficiency in the construction of certain motorcycle footrest peg supports, and in particular on some Ducati® motorcycles.

Certain motorcycle footrest pegs, and in particular those used in some Ducati brand motorcycles, are weakly connected to the main frame through two metal tabs. In the event of the motorcycle tipping over or sliding, the bending moment created due to the footrest peg making contact with the ground can cause the metal tabs to bend, causing permanent damage to the motorcycle frame. In a preferred embodiment of a motorcycle footrest peg reinforcement described herein, a reinforcement support plate indirectly connects the footrest peg support plate to another strong frame location, such as an engine mounting hole or recess, thus providing stress relief for the metal tabs and preventing frame damage.

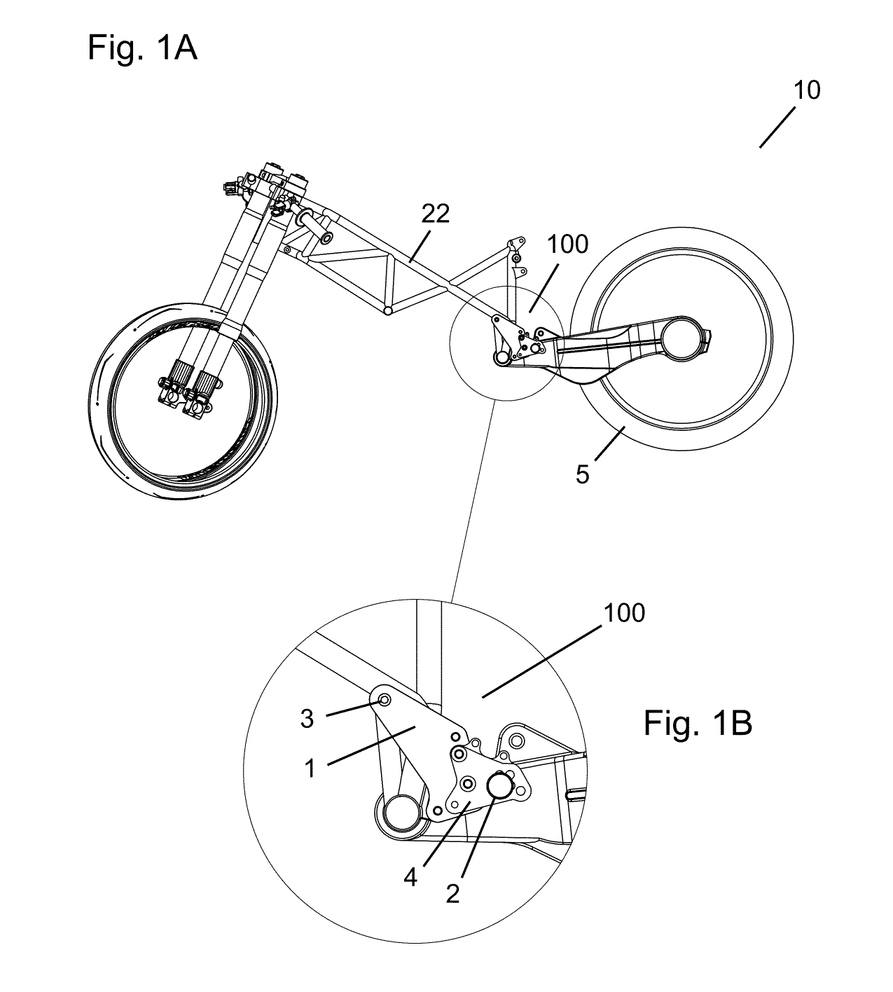

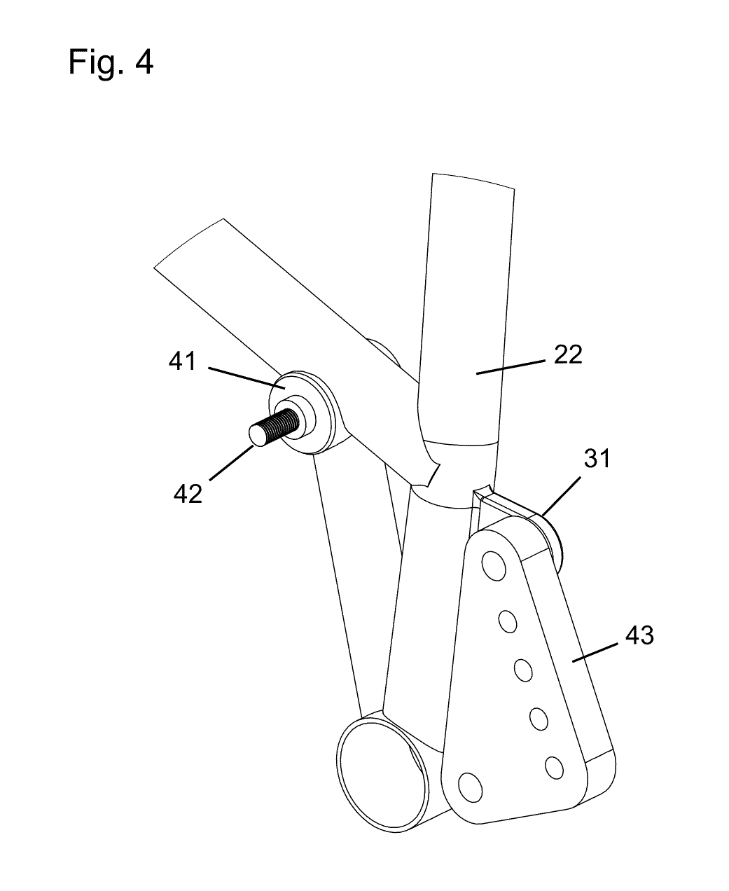

FIGS. 1A and 1B show a motorcycle 10 with a frame 22, two wheels 5, and a footrest peg assembly 100. The footrest peg assembly 100 shown corresponds to an embodiment of a footrest peg assembly 100 of the present invention, and includes a reinforcement support plate 1, a peg support plate 4, a mounting plate 43 (shown in FIG. 4), and the footrest peg 2 itself The peg support plate 4 and the mounting plate 43 are both preferably made of aluminum. A primary improvement over the prior art is the addition of a reinforcement support plate 1, which connects the footrest peg 2 to the engine mounting location 3.

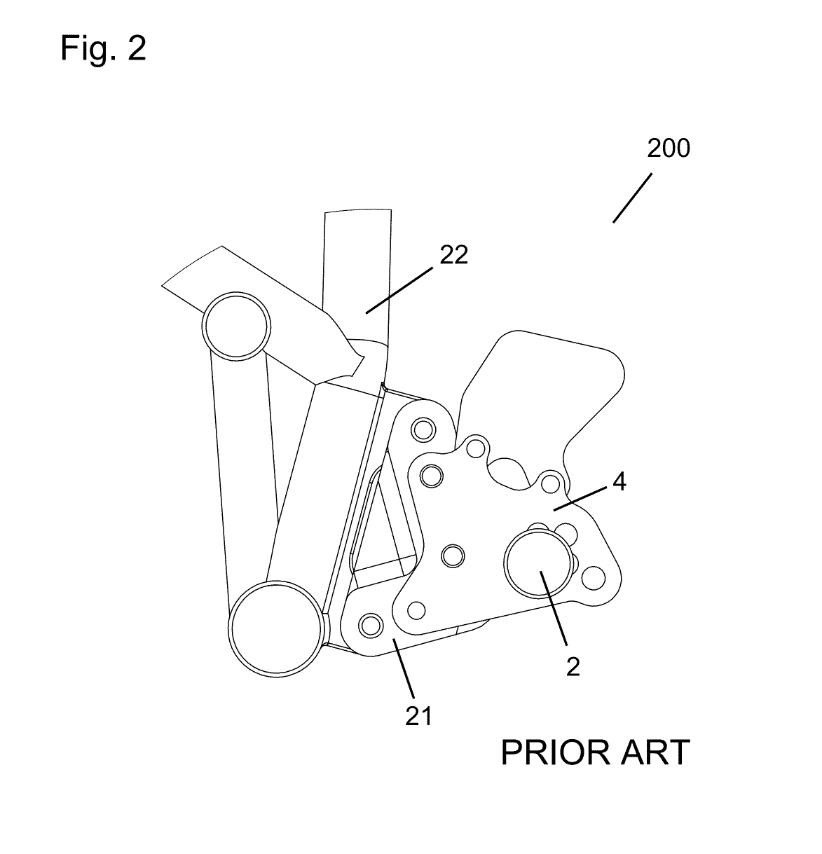

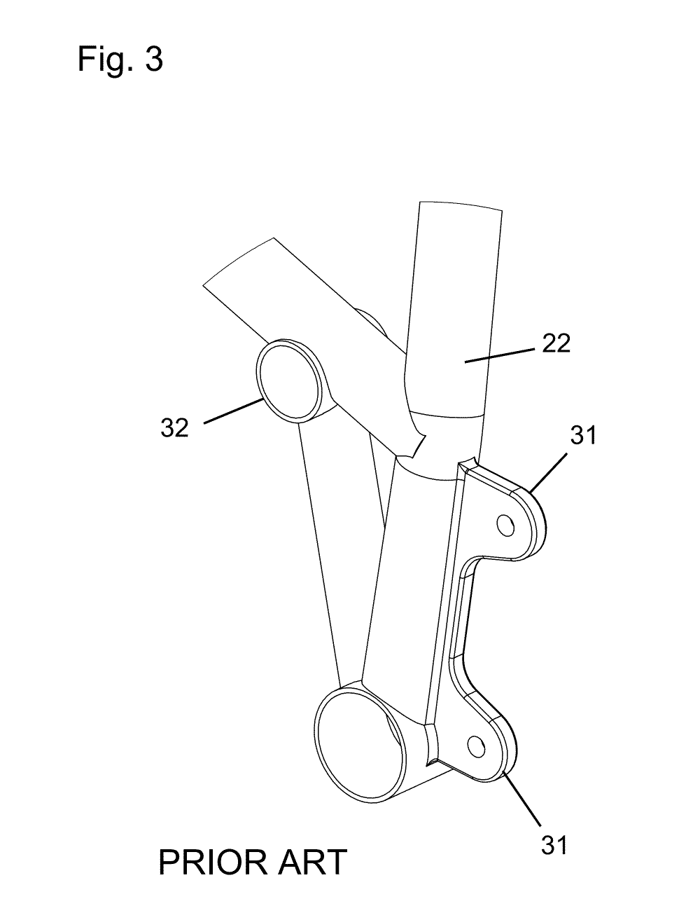

FIG. 2 shows a prior art footrest peg assembly 200. As shown in the figure, an aluminum mounting plate 21 is bolted to two metal tabs 31 (shown in FIG. 3), which are in turn welded to the main frame 22. This type of connection is weak due to the limited bending support offered by the tabs 31. In particular, if the motorcycle is laid flat on its side, for example upon losing control around a turn or the vehicle falling over from upright, the tabs 31 will bend. The resulting damage requires a major disassembly of the motorcycle in order to repair the tabs 31.

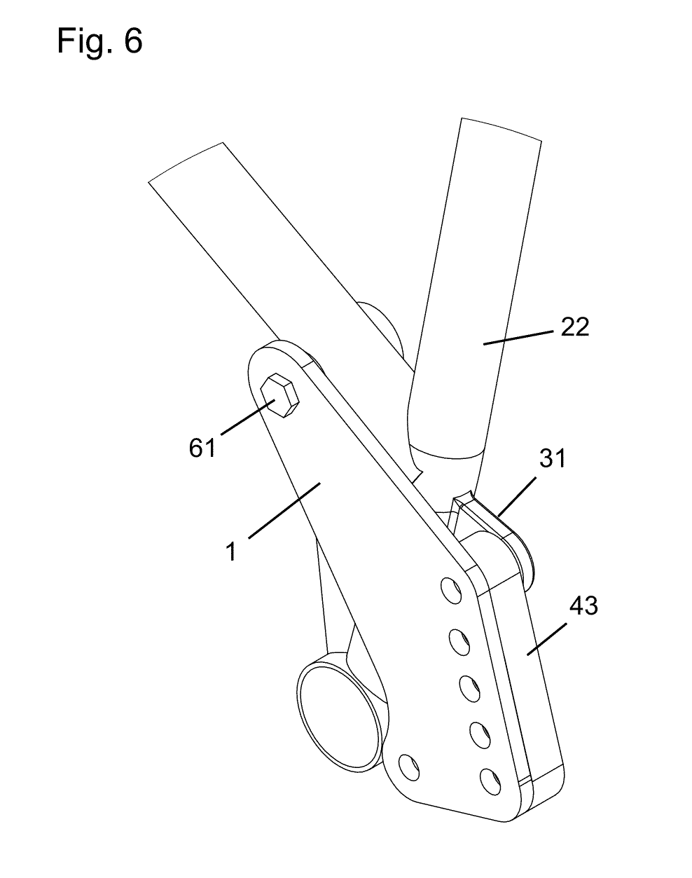

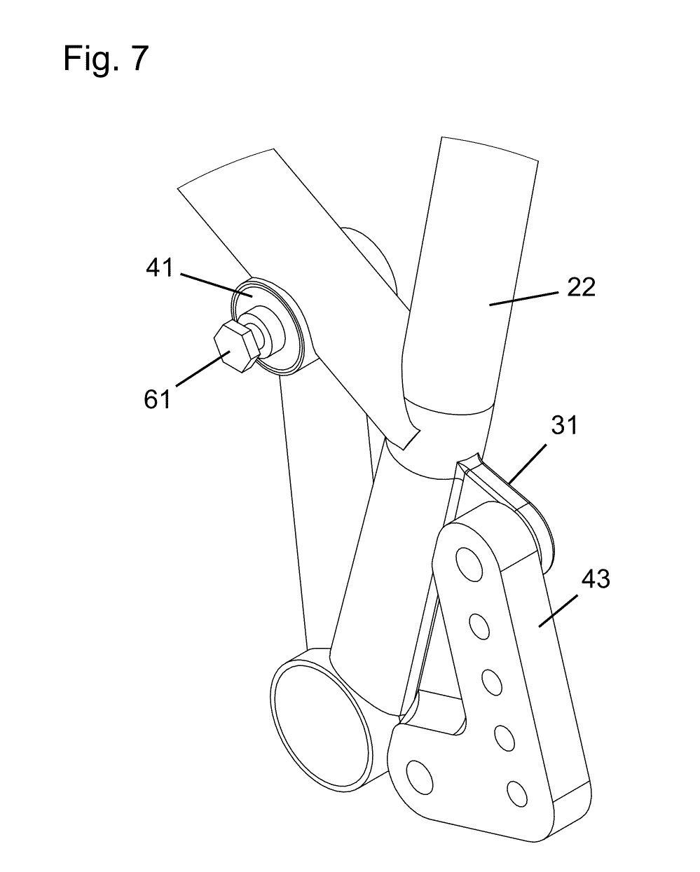

The footrest peg reinforcements described herein relieve the high bending stresses in the tabs 31 by transmitting a majority of the load to a stronger location within the motorcycle frame 22. To accomplish this, an insert or expansion plug 41 and a fastener or threaded stud 42 are preferably placed inside an engine mounting hole 32 (shown in FIG. 3), as shown in FIG. 4. In one preferred embodiment, the expansion plug is made of rubber. In other preferred embodiments, the expansion plug 41 may be made of another material including, but not limited to, urethane, plastic, or metal. The expansion plug 41 connects a reinforcement support plate 1 to the strongest part of the motorcycle frame 22, while the reinforcement support plate 1 connects this frame location to a mounting plate 43. In another preferred embodiment, the insert or expansion plug 41 is a threaded receptacle and the fastener is a bolt 61 instead of a threaded stud 42, as shown in FIGS. 6 and 7.

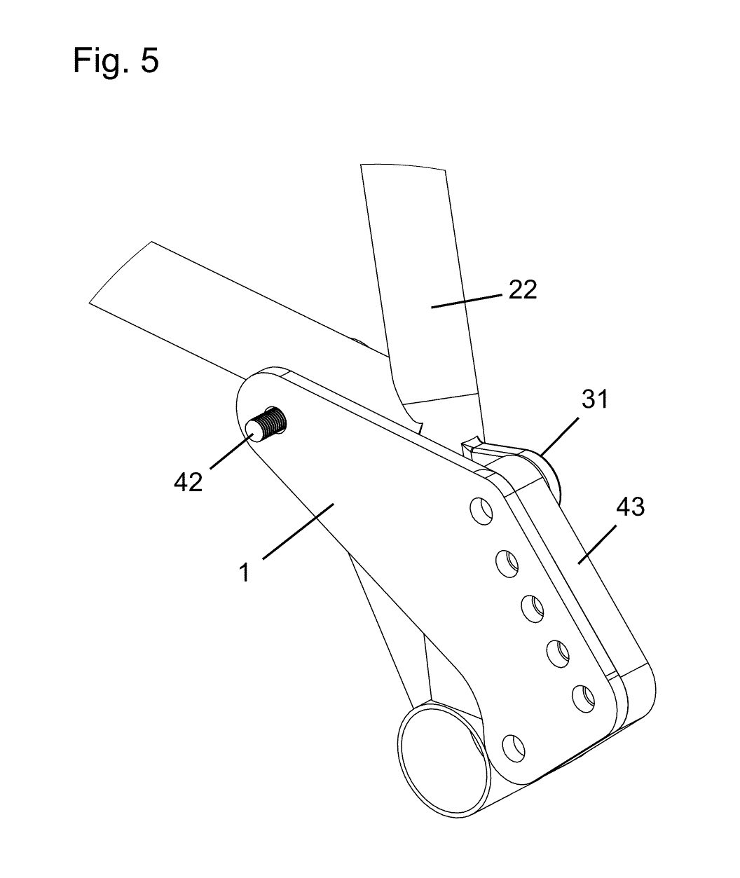

In one preferred embodiment, the reinforcement support plate 1 is made of carbon fiber. In other preferred embodiments, the material for the reinforcement support plate 1 may be any strong material or combination of materials including, but not limited to, fiberglass, aramid (for example, Kevlar® aramid fibers), carbon fiber, aluminum, steel, titanium, plastic, or any combination of fiberglass, aramid (for example, Kevlar® aramid fibers), carbon fiber, aluminum, steel, titanium, or plastic. The reinforcement support plate 1 is shown mounted in place in FIG. 5. This design strengthens the support of the footrest peg 2 by directly connecting the aluminum mounting plate 43, and hence tabs 31, to the engine mounting location 32. The long lever arm provided by the reinforcement support plate 1 prevents damage to the tabs 31 by relieving the high bending stresses in the event of the motorcycle laying down on its side.

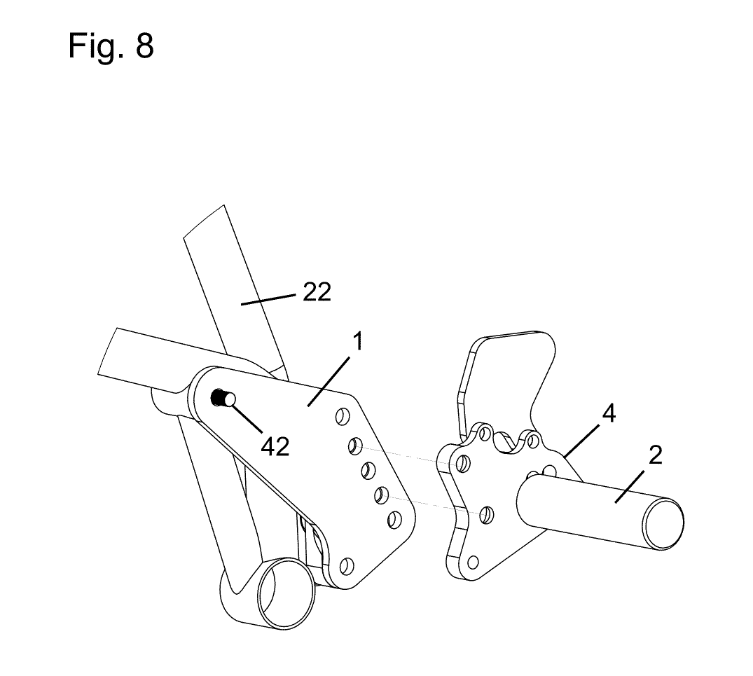

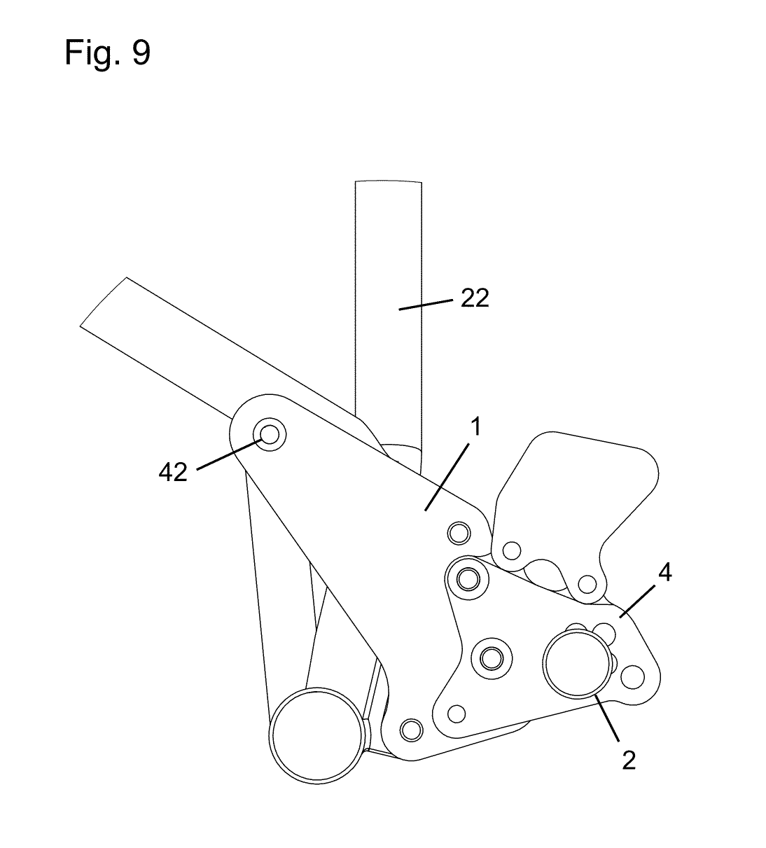

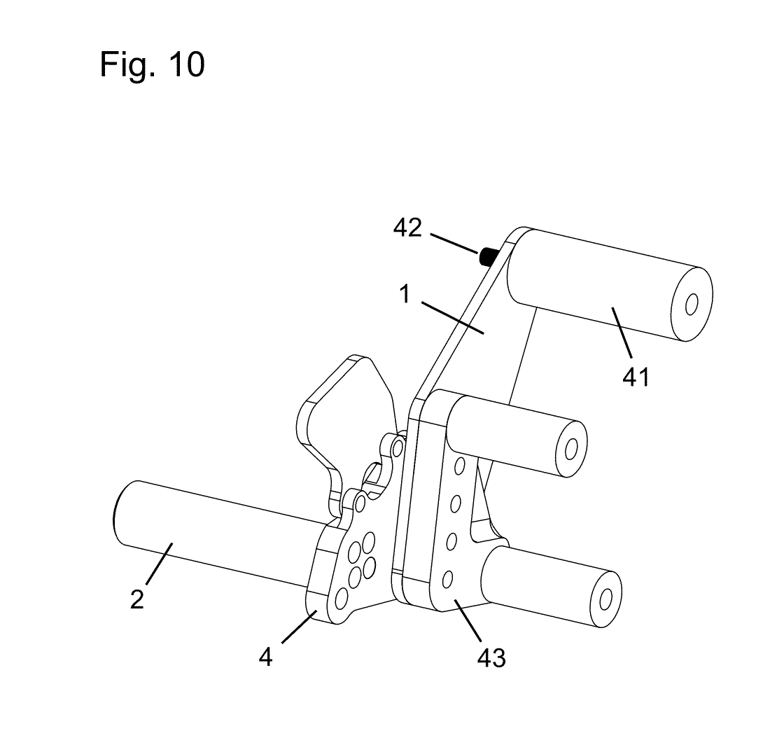

FIG. 8 shows the peg support plate 4 and footrest peg 2 separated from the reinforcement support plate 1. The completed assembly is shown in FIG. 9. An alternate view of the completed footrest peg assembly is shown in FIG. 10.

In one preferred embodiment, the motorcycle footrest peg assembly is used on a Ducati brand motorcycle or motorcycle frame (Ducati Motor Holdings S.P.A., Bologna, Italy).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A motorcycle footrest peg assembly comprising:
a) a motorcycle footrest peg;
b) a peg support plate connected to the footrest peg;
c) an expansion plug; and
d) a reinforcement support plate connected to the peg support plate and the expansion plug, wherein the reinforcement support plate indirectly connects the peg support plate to the motorcycle frame.

2. The motorcycle footrest peg assembly of claim 1, further comprising a threaded stud inserted into the expansion plug.

3. The motorcycle footrest peg assembly of claim 1, wherein the support plate is bolted to the expansion plug.

4. The motorcycle footrest peg assembly of claim 1, wherein the motorcycle frame is a Ducati brand motorcycle frame.

5. The motorcycle footrest peg assembly of claim 1, further comprising a pair of tabs welded to the motorcycle frame and a mounting plate connected to the tabs on a first side of the mounting plate, wherein the reinforcement support plate is connected to the mounting plate on a second side of the mounting plate opposite the first side of the mounting plate.

6. The motorcycle footrest peg assembly of claim 1, wherein the reinforcement support plate is made of carbon fiber.

7. The motorcycle footrest peg assembly of claim 1, wherein the reinforcement support plate is made of a material selected from the group consisting of:
a) fiberglass;
b) aramid;
c) carbon fiber;
d) aluminum;
e) steel;
f) titanium;
g) plastic; and
h) any combination of a) through g).

8. A motorcycle comprising:
a) a motorcycle frame;
b) a motorcycle footrest assembly attached to the frame, comprising:
i) a motorcycle footrest peg;
ii) a peg support plate connected to the footrest peg;
iii) an expansion plug; and
iv) a reinforcement support plate connected to the peg support plate and the expansion plug, wherein the reinforcement support plate indirectly connects the peg support plate to the motorcycle frame.

9. The motorcycle of claim 8, further comprising a threaded stud inserted into the expansion plug.

10. The motorcycle of claim 8, wherein the support plate is bolted to the expansion plug.

11. The motorcycle of claim 8, further comprising a pair of tabs welded to the motorcycle frame and a mounting plate connected to the tabs on a first side of the mounting plate, wherein the reinforcement support plate is connected to the mounting plate on a second side of the mounting plate opposite the first side of the mounting plate.

12. The motorcycle of claim 8, wherein the motorcycle frame is a Ducati brand motorcycle frame.

13. The motorcycle of claim 8, wherein the reinforcement support plate is made of carbon fiber.

14. The motorcycle of claim 8, wherein the reinforcement support plate is made of a material selected from the group consisting of:
a) fiberglass;
b) aramid;
c) carbon fiber;
d) aluminum;
e) steel;
f) titanium;
g) plastic; and
h) any combination of a) through g).

15. A motorcycle footrest peg assembly comprising:
a) a motorcycle footrest peg;
b) a peg support plate connected to the footrest peg;
c) an expansion plug and a fastener inserted into an engine mounting hole in a motorcycle frame; and
d) a reinforcement support plate connected to the peg support plate and the fastener, wherein the reinforcement support plate indirectly connects the peg support plate to the motorcycle frame.

16. The motorcycle footrest peg assembly of claim 15, wherein the fastener is selected from the group consisting of a threaded stud and a bolt.

17. The motorcycle footrest peg assembly of claim 15, wherein the motorcycle frame is a Ducati brand motorcycle frame.

18. The motorcycle footrest peg assembly of claim 15, further comprising a pair of tabs welded to the motorcycle frame and a mounting plate connected to the tabs on a first side of the mounting plate, wherein the reinforcement support plate is connected to the mounting plate on a second side of the mounting plate opposite the first side of the mounting plate.

19. The motorcycle footrest peg assembly of claim 15, wherein the reinforcement support plate is made of carbon fiber.

20. The motorcycle footrest peg assembly of claim 15, wherein the reinforcement support plate is made of a material selected from the group consisting of:
a) fiberglass;
b) aramid;
c) carbon fiber;
d) aluminum;
e) steel;
f) titanium;
g) plastic; and
h) any combination of a) through g).
